(19) United States
(12) Patent Application Publication
(10) Pub. No.: US 2009/0301282 A1
(43) Pub. Date: Dec. 10, 2009

(54) Material Corner Shaper

(75) Inventors: Douglas Nelson, Madison, WI (US); Lisa Painter, Madison, WI (US); Rebecca Lidstrom, Madison, WI (US); Peter Cooper, Bronte (AU); Sam Trewartha, Crows Nest (AU); Stephen Chan, Kwai Chug (HK)

Correspondence Address: FOLEY & LARDNER LLP, 321 NORTH CLARK STREET, SUITE 2800, CHICAGO, IL, 60654-5313, US

(73) Assignee: Fiskars Brands, Inc.

(21) Appl. No.: 12/136,632

(22) Filed: Jun. 10, 2008

(51) Int. Cl. B26D 1/00

(52) U.S. Cl. 83/694

(57) ABSTRACT

A cutting apparatus for cutting a corner from sheet material to a selectable profile. In one set of embodiments, the cutting apparatus comprises a cutting assembly that includes a cutting element having a plurality of cutting profiles wherein each cutting profile may have a unique profile. The cutting assembly is configured such that an active cutting profile is selectable from the plurality of cutting profiles available on the cutting element. Engagement of the active cutting profile with one or more pieces of sheet material cuts a corner from the sheet material to a profile indicative of the active cutting profile. Cutting profiles may include curves having a uniform or variable radius of curvature and other forms appropriate for cutting a corner of sheet material.

### FIELD OF THE INVENTION

The present invention relates generally to the field of devices to cut sheet material. More particularly the present invention relates to devices for cutting the corners from sheet material.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various conventional systems for cutting a corner from sheet material are known. Some such systems provide for a corner cutting system comprising at least one moveable cutting element configured to cut a corner from a sheet of material. The cutting element is generally coupled to a handle or other member for operation of the cutting element. The handle may be biased with respect to a base structure that is configured to accept the sheet material and the cutting element. Some such systems allow for the disassembly of the cutting element from the system and installation of a different cutting element, while other systems include multiple cutting elements and a base, with multiple corresponding cutting areas preconfigured to accept the cutting elements.

### SUMMARY OF THE INVENTION

Various embodiments of the present invention comprise systems and methods for cutting a corner from one or more pieces of sheet material. Embodiments of the system are configurable such that corners of sheet material may be cut to multiple unique profiles.

In one set of embodiments, a cutting apparatus comprises a cutting assembly that includes a cutting element having a plurality of cutting profiles, wherein each cutting profile may have a unique profile. The cutting assembly is operatively coupled to at least one of a pair of operatively coupled handles. The cutting assembly is configured such that an active cutting profile is selectable from the plurality of cutting profiles available on a cutting element. A selection tab operatively coupled to the cutting assembly may be provided for selection of the active cutting profile. The selection tab may be configured such that it can be orientated in a secured orientation, where the selection tab is at least partially received in one of the handles, or in an unsecured orientation, where the selection tab is at least partially elevated away from the handle for efficient operation. In the unsecured orientation, the active cutting profile may be selected by operation of the selection tab. In the secured orientation, the active cutting profile is substantially constrained for cutting operations. By compressing the operatively coupled handles, the active cutting profile engages and cuts a corner from the one or more pieces of sheet material to a profile indicative of the active cutting profile. Cutting assemblies may include a plurality of cutting profiles having unique profiles, such as curves having a uniform or variable radius of curvature appropriate for cutting a corner from sheet material.

Embodiments of the present invention permit a corner having a selected profile to be cut from sheet material. A convenient flip-up selection tab may be provided to permit selection of the active cutting profile from a plurality of cutting profiles available on the corner cutter. The flip-up tab also ensures that the active cutting profile is properly aligned with the material to be cut and further secures the active cutting profile with respect to the handles of the corner cutter during cutting operations. By providing a plurality of cutting profiles that are conveniently selectable, an efficient apparatus for cutting a corner from sheet material is provided.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a top perspective view of one embodiment of the present invention, showing a top handle, a bottom handle, a cutting assembly, and selection tab;

FIG. 2 is a bottom perspective view of the corner cutter of FIG. 1;

FIG. 3 is an exploded view of the corner cutter of FIG. 1, showing components of the corner cutter including a cutting element, an upper collar, and a rotator;

FIG. 4 is a bottom perspective view with a piece of sheet material inserted in the corner cutter of FIG. 1;

FIG. 5A is a detailed bottom perspective view of the cutting element of FIG. 3;

FIG. 5B is a detailed top perspective view of the cutting element of FIG. 3;

FIG. 6A is a detailed bottom perspective view of the upper collar of FIG. 3;

FIG. 6B is a detailed top perspective view of the upper collar of FIG. 3;

FIG. 7 is an end view of the corner cutter of FIG. 1;

FIG. 8A is a detailed bottom perspective view of the rotator of FIG. 3; and

FIG. 8B is a detailed top perspective view of the rotator of FIG. 3.

### DETAILED DESCRIPTION OF THE PREFERRED EMBODIMENTS

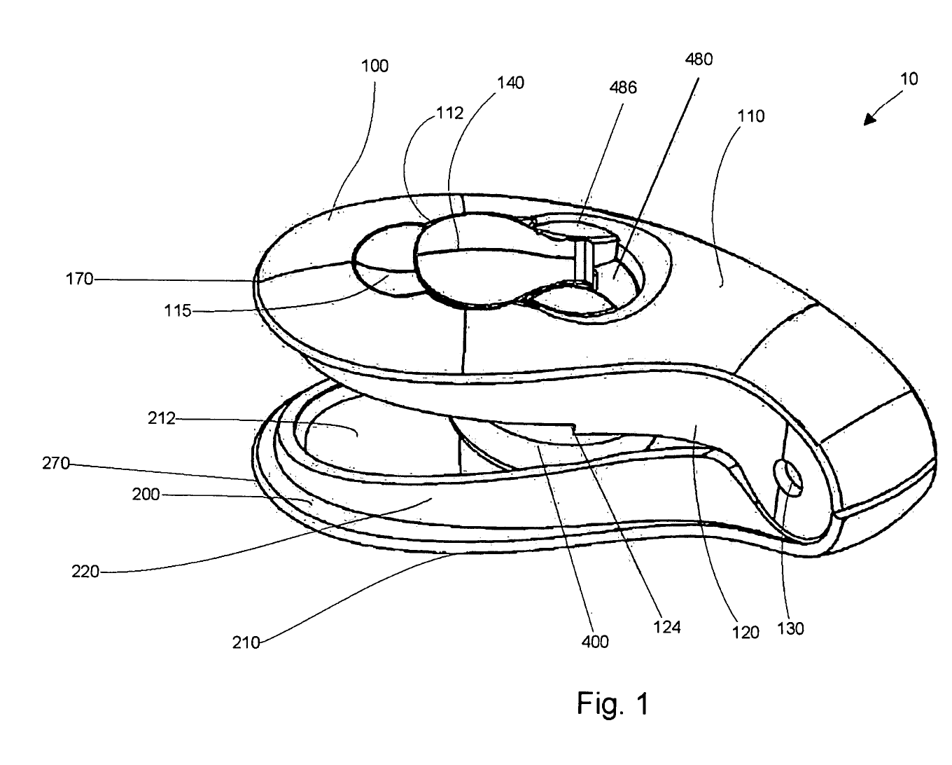

FIG. 1 illustrates a corner cutter 10 constructed in accordance with an embodiment of the present invention. The corner cutter 10 comprises a top handle 100 operatively coupled to a bottom handle 200 at a hinge 130. The cutting system may further comprise a cutting assembly 400 operatively coupled to the top handle 100. The cutter assembly may further be selectively orientated with respect to the top handle 100 by operation of a selection tab 140.

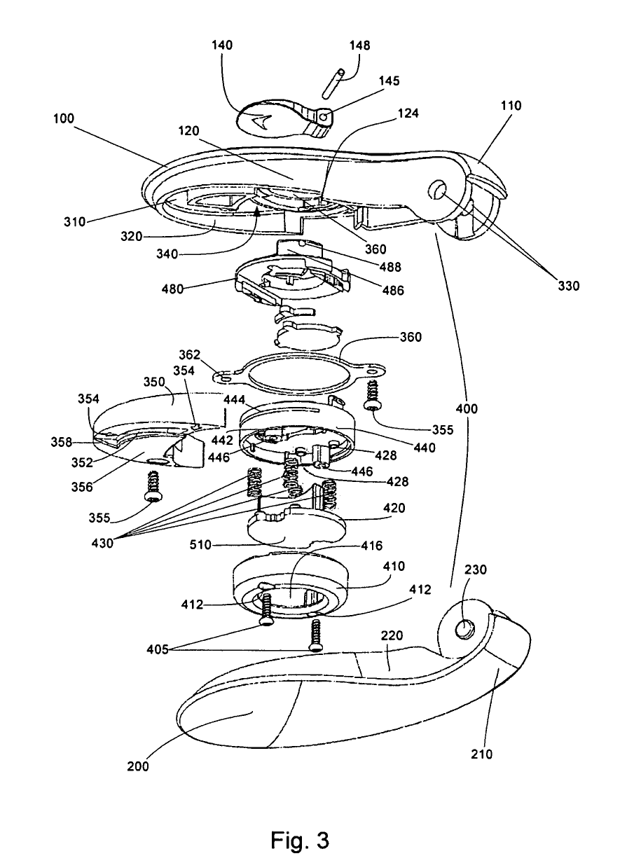

In the embodiment of FIG. 1, the top handle 100 generally comprises an elongated member including a top member 110 and an upper side member 120 extending downward from the top member 110. The upper side member is disposed about at least a portion of the perimeter of the top member 110. As seen in FIG. 3, the upper side member 120 includes a pair of coaxial holes 330 disposed at the location of the hinge 130. The bottom handle 200 has a substantially similar configuration to that of the of the top handle 100 and generally comprises an elongated member including a bottom member 210 and a lower side member 220 extending upward from the bottom member 210. The lower side member is disposed about at least a portion of the perimeter of the bottom member 210. The lower side member 200 includes a pair of coaxial axle portions 230 disposed at the location of the hinge 130. The pair of coaxial holes 330 of the upper handle are configured to operatively align with the corresponding pair of axle portions 230 to rotatably couple the top handle 100 and the bottom handle 200. Application of a compressive load on the top handle 100 and the bottom handle 200 decreases the distance between a leading edge 170 of the top handle 100 and a leading edge 270 of the bottom handle 200.

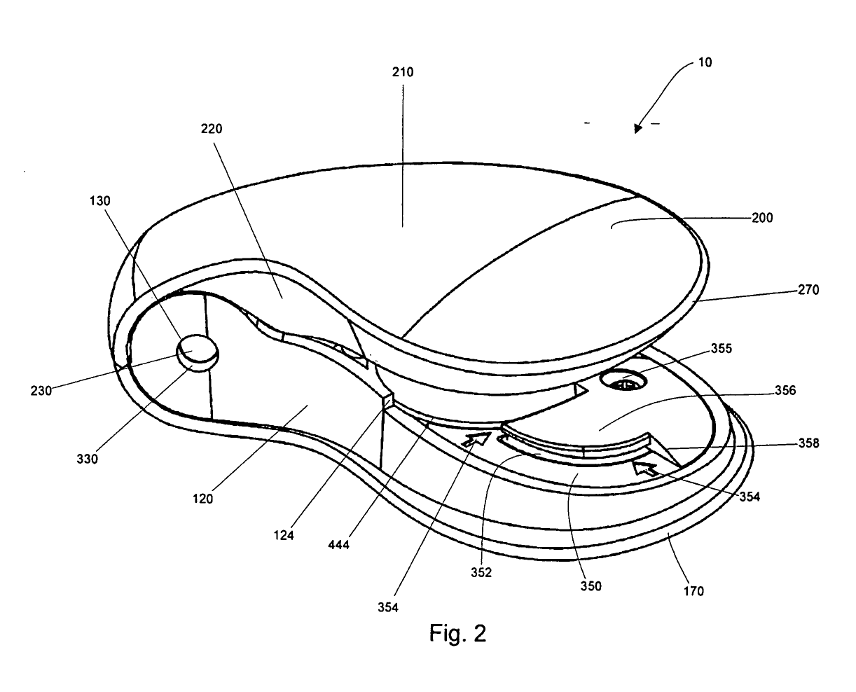

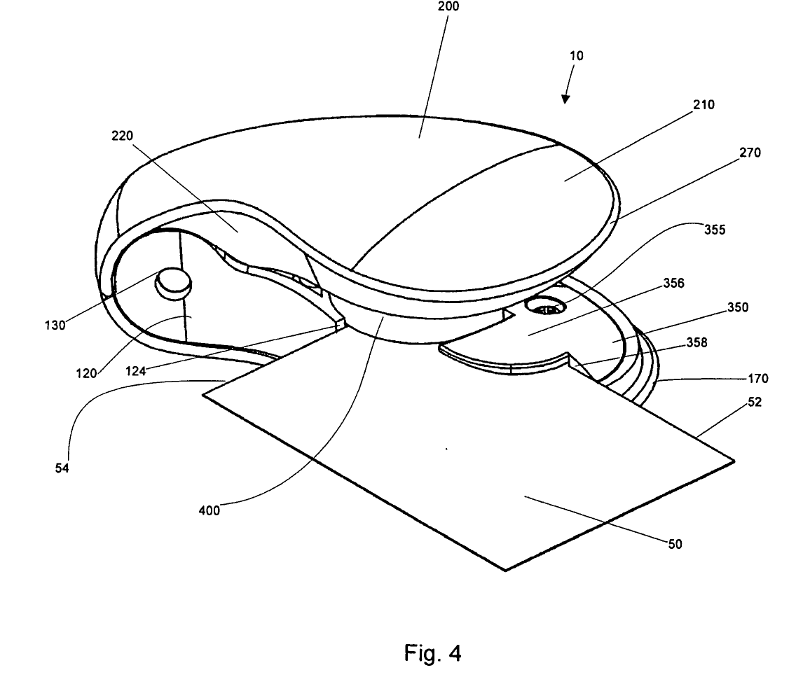

As seen in FIG. 3, a bottom surface 310 disposed on the underside of the top member 110 and a medial surface 320 disposed on the interior of the upper side member 120 partially form a region 340 on the underside of the top handle 100. The cutting assembly 400 is partially contained within the region 340. The cutting assembly 400 is coupled to the top handle, with a bracket 360 and one or more fasteners 355. Alternatively, the cutting assembly 400 can be coupled to the top handle 100 by other methods of securement known in the art. One or more fasteners 355 may further secure a material guide 350 to the cutting assembly 400 and the top handle 100. The material guide 350 is disposed partially within the region 340 and comprises a raised surface 356, a guide slot 352, and a first material stop 358. As seen in FIG. 2, the guide slot 352 is configured to accept one or more sheets of material to be cut in the corner cutter 10. A piece of material 50 is slid under the raised surface 356 up to the first material stop 358. As seen in FIG. 4, the material 50 is further orientated by positioning the material such that it abuts a second material stop 124 disposed on the upper side member 120. Optionally, positioning indicia 354 may be included on the material guide 350 to guide orientation of the material with respect to the corner cutter 10.

FIG. 3 illustrates an embodiment of the corner cutter 10 with the components of the cutting assembly 400. The cutting assembly 400 comprises a lower collar 410, a cutting die 420, one or more biasing members 430, an upper collar 440, and a rotator 480. The cutting die 420 is slidingly constrained within a housing formed by the lower collar 410 and the upper collar 440. The lower collar 410 is secured to the upper collar 440 by one or more fasteners 405 passing through one or more corresponding holes 412 disposed in the lower collar 410 and threadedly engaging one or more corresponding bosses 442 disposed on the upper collar 440. The one or more biasing members 430 are positioned between and are operatively coupled to the upper collar 440 and the cutting die 420 such that the one or more biasing members 430 assert a substantially normal biasing force on the cutting die 420, biasing the cutting die 420 toward the lower collar 410. The upper collar 440 and the cutting die 420 may further include one or more biasing member retaining protrusions 428 configured to operatively couple to and assist in maintaining the orientation of the corresponding one or more biasing members 430. The height of the biasing member retaining protrusions 428 may be configured to limit translation of the cutting die 420 between the lower collar 410 and the upper collar 440 to prevent over compression of the biasing members 430.

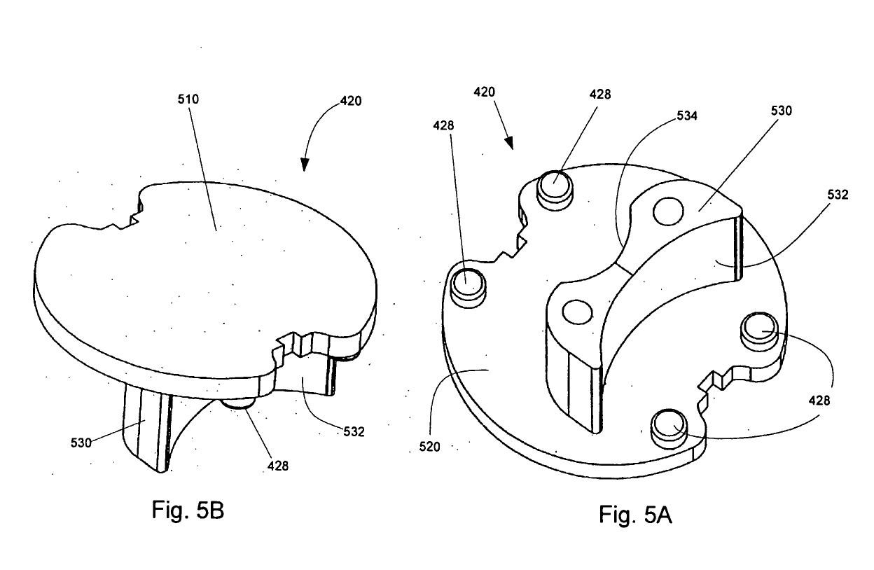

In the embodiment illustrated in FIGS. 5A and 5B, the cutting die 420 comprises a bottom surface 510 and a top surface 520. A cutting element 530 is disposed on the top surface 520 and extends upwardly from the top surface 520 and is configured with one or more cutting profiles. In the embodiment of FIG. 5A, a first cutting profile 532 and a second cutting profile 534 are orientated on the cutting element 530 about 180 degrees from each other. However, other configurations of the cutting die 420 and the cutting element 530 may be constructed. For example, an embodiment of the cutting element 530 could be constructed with four cutting profiles, each cutting profile located about 90 degrees from an adjacent cutting profile. Also, the cutting die 420 could be constructed with more than one cutting element 530, each including one or more cutting profiles. Each cutting profile may have a unique profile. In the embodiment of FIG. 5A, the first cutting profile 532 is configured with a profile having a particular radius of curvature, and the second cutting profile 534 is configured with a profile having a lesser radius of curvature than that of the first cutting profile 532. Numerous configurations of the cutting profiles may be constructed having greater or lesser radii of curvature than illustrated or having alternative profiles, including, but not limited to, linear, elliptical, parabolic, corrugated, or other profiles desirable for cutting a corner from sheet material. The cutting patterns may also comprise more irregular shapes, resulting in a wide variety of potential patterns.

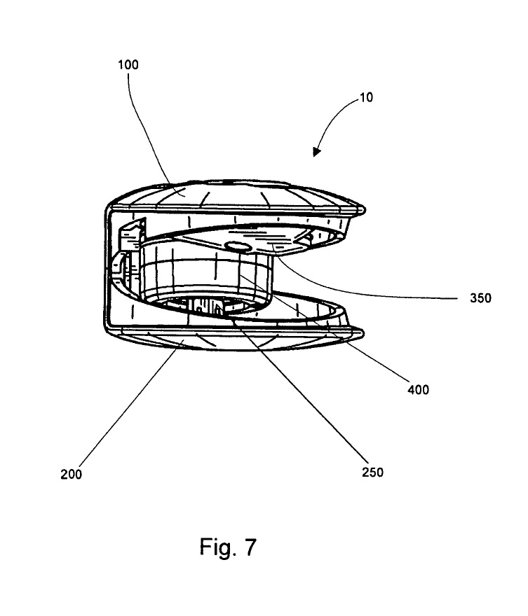

As shown in FIG. 3, the lower collar 410 includes a through hole 416 that provides access to the bottom surface 510 of the cutting die 420. As seen in FIG. 7, the bottom handle 200 includes an actuating probe 250 extending upwardly from an inner surface 212 of the bottom member 210 of the bottom handle 200. The actuating probe 250 engages the bottom surface 510 of the cutting die 420 when a compressive load is applied to the top handle 100 and the bottom handle 200. Further compression of the top handle 100 and the bottom handle 200 results in application of a substantially normal force to the bottom surface 510. Upon sufficient compressive load to the top handle 100 and the bottom handle 200, the biasing force of the biasing members 430 is overcome, compressing the biasing members 430 and translating the cutting die 420 toward the upper collar 440. Reduction of the compressive load from the top handle 100 and the bottom handle 200 results in the one or more biasing members 430 acting with the biasing force on the cutting die 420 to translate the cutting die 420 and the actuating probe 250 back toward to their respective initial positions. The one or more biasing members 430 are selected to provide sufficient biasing force to actuate the return of the cutting die 420 to its initial position and to return the top handle 100 and the bottom handle 200 to an open orientation with release of the compressive load. The one or more biasing members 430 are also selected to provide for comfortable operation so that a reasonable load applied by a user to the top handle 100 and the bottom handle 200 actuates the cutting die 420 to cut the corner from the sheet material 50. Coil springs may be used as the biasing members 430 in a particular embodiment. In other embodiments, alternative biasing structures known in the art may be used as the biasing members.

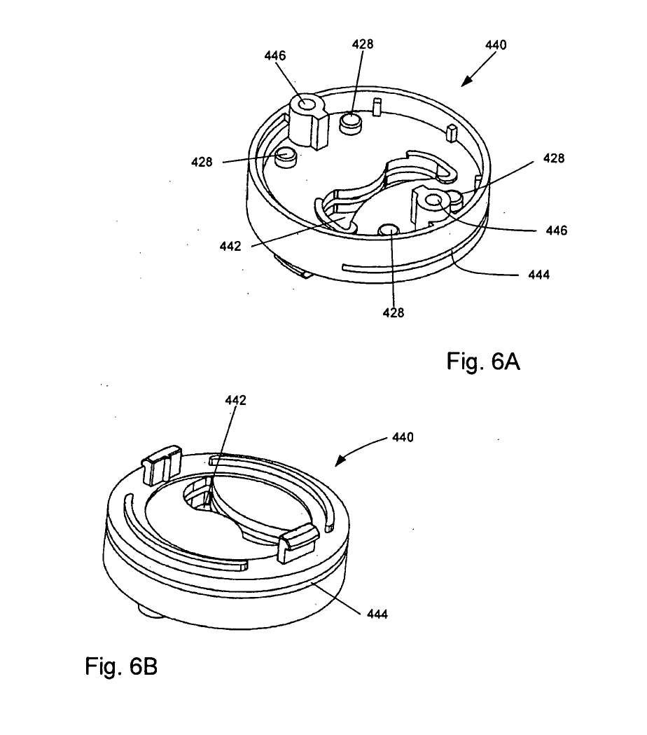

FIGS. 6A and 6B show an embodiment of the upper collar 440 in detail. The upper collar 440 includes a opening 441 that permits passage of the cutting element 530 during operation. As shown, the opening 441 has a substantially similar shape to that of the cutting element 530 but is slightly larger to permit sufficient clearance for the passage of the cutting element 530. Correlation of the shape and size of the opening 441 to the cutting element 530 enhances the cutting efficacy of the corner cutter 10. The upper collar 440 also includes one or more material slots 444 disposed around the perimeter of the upper collar 440 and configured for sliding the material 50 into the upper collar 440 for cutting. The location of the one or more material slots 444 correspond to the configuration of the cutting element 530. For example, for the embodiment of the cutting element depicted in FIG. 5A, the one or more material slots 444 are configured for access by the material 50 to the first cutting profile 532 and to the second cutting profile 534.

FIG. 3 shows an assembly comprising the lower collar 410, the cutting die 420, and the upper collar 440, which is coupled to the rotator 480, and thereby forming the cutting assembly 400. The rotator 480 is operatively coupled to the top handle 100 and retained by the bracket 360. The bracket 360 is secured to the top handle 100 with the fasteners 355 or by other methods of securement known in the art. The bracket 360 permits rotation of the rotator 480 within the top handle 100 and the cutting assembly 400 about an axis substantially normal to a plane defined by the material 50 inserted into the corner cutter 10, as shown in FIG. 4. The cutting assembly 400 is rotated with respect to the top handle 100 to align the cutting element 530 such that a cutting profile of the cutting element 530, such as the first cutting profile 532 or the second cutting profile 534, is substantially aligned in relation to the first material stop 358 and the second material stop 124 and a corner of the material 50.

The cutting assembly 400 may also be configured such that it is disengageable from the top handle 100 and interchanged with a new cutting assembly 400. Interchange of the cutting assembly permits replacement of the cutting element 530 if it is worn or insertion of a cutting assembly 400 with different cutting profiles. Alternatively, the cutting assembly 400 may also be configured such that the cutting element 530 is interchangeable instead of the whole of the cutting assembly 400. Interchange of the cutting element 530 offers the same advantages of interchange of the cutting assembly 400 in a potentially more economical manner.

As depicted in FIG. 5A, the cutting die 420 includes the cutting element 530 having a first cutting profile 532 and a second cutting profile 534, the cutting assembly 400 is configured to be orientated with respect to the top handle 100 in a first orientation corresponding to use of the first cutting profile 532 and a second orientation corresponding to use of the second cutting profile 534. The cutting profile orientated for use is the active cutting profile. In this embodiment, the first orientation is disposed about 180 degrees from the second orientation. The cutting assembly 400 is capable of a full 360 degree rotation or is alternatively limited to a rotation of about 180 degrees, with respect to the top handle 100 to achieve the first and second orientations. A selection tab 140 may be operatively coupled to the cutting assembly 400 to facilitate rotation of the cutting assembly 400.

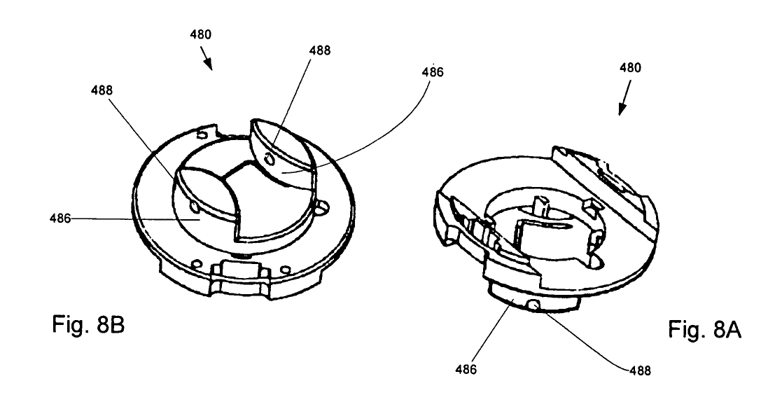

As shown in FIG. 3, the selection tab 140 is operatively coupled to the rotator 480 by an axle 148 partially residing within a through hole 145 in the selection tab 140. As seen in FIGS. 8A and 8B, a pair of coaxial holes 488 are provided in the rotator 480 and are configured to slidingly accept the axle 148. In this configuration, the selection tab 140 is deployed by rotating the selection tab 140 outwardly from a lowered secured position away from the top handle 100 about the axle 148. The selection tab 140 is readily graspable by a user in the deployed unsecured position to assist in the rotation of the cutting assembly 400. As illustrated in FIG. 1, the top member 110 may be configured with a tab recess 112 to at least partial accommodate the selection tab 140 in the top handle 100 when the selection tab 140 is in the secured position. When rotating the cutting assembly 400, proper orientation of the of the cutting assembly 400 in the first or the second orientation is readily achieved by aligning the selection tab 140 with the tab recess 112. One or more detents may also be used to secure the cutting assembly 400 in a proper position. Additionally, by lowering the selection tab 140 into the tab recess 112, the selection tab 140 may be substantially secured, thereby locking the rotational position of the cutting assembly and the active cutting profile, in the desired orientation for cutting operations. An access recess 115 may be disposed on the top member 110 proximate to the tab recess 112 to facilitate access to the selection tab 140 when in the lowered position. Indicia representative of the cutting profiles may be included on the selection tab 140 and/or the cutting assembly 400 to readily indicate to the user the active cutting profile.

Material is cut with the corner cutter 10 by first selecting the active cutting profile from the available cutting profiles of the cutting element 530. If the cutting assembly 400 is orientated in the top handle 100 such that the desired cutting profile is not the active cutting profile, then the cutting assembly 400 is rotated until the desired cutting profile is positioned for use as the active cutting profile. Rotation of the cutting assembly 400 is accomplished by lifting the selection tab 140 from the secured position in the tab recess 112 to the unsecured position and then rotating the selection tab 140 until the cutting assembly 400 obtains the desired position. The rotational position of the cutting assembly 400 is maintained by lowering the selection tab 140 back into the tab recess 112. Next, the material 50 to be cut is orientated in the corner cutter 10, as shown in FIG. 4. Orientation of the material 50 is achieved by inserting a corner of the material 50 into the material slot 444 a first edge 52 of the material 50 into the guide slot 352 and under the raised surface 356 until the first edge 52 abuts the first material stop 358 and a second edge 54 of the material 50 abuts the second material stop 124. Next, a compressive load is gradually applied to the top handle 100 and the bottom handle 200 thereby reducing the distance between the leading edge 170 of the top handle 100 and the leading edge 270 of the bottom handle 200. Simultaneously, the actuating probe 250 engages the bottom surface 510 of the cutting die 420 and translates the cutting die 420 toward the material 50 captured in the upper collar 440. In translating the cutting die 420, the active cutting profile of the cutting element 530 impinges the material 50, thereby cutting the corner from the material 50 to the profile of the active cutting profile. The compressive load is then gradually removed from the top handle 100 and the bottom handle 200, allowing the biasing force of the one or more biasing members 430 to act on the cutting die 420 and translate the cutting die 420 back toward the lower collar 410. Simultaneously, the distance between the leading edge 170 of the top handle 100 and the leading edge 270 of the bottom handle 200 is increased. The material 50, having been cut, is then removed from the corner cutter 10. The process, as described immediately above, may be repeated to cut remaining corners of the material 50 or additional material.

Embodiments of the present invention are particularly useful for rounding the corners of paper materials. However, one skilled in the art will appreciate that the present invention is not limited to the rounding of corners but may be employed to cut a variety of shapes in paper and other relatively thin sheet materials, including fabrics, polymer and rubber type materials, metals, and woods. Additionally, it will be appreciated that multiple layers of the same or different materials may be cut simultaneously using the present invention.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described to explain the principles of the present invention and its practical application to enable one skilled in the art to utilize the present invention in various embodiments and with various modifications as are suited to the particular use contemplated.

What is claimed is:

1. An apparatus for cutting a portion from sheet material, comprising:
a first member operatively coupled to a second member; and
a cutting assembly operatively coupled to the first member, the cutting assembly including a plurality of cutting profiles,
wherein an active cutting profile is selectable from among the plurality of cutting profiles and is engageable with one or more pieces of sheet material.

2. The apparatus of claim 1, wherein each of the plurality of cutting profiles has a unique cutting profile.

3. The apparatus of claim 2, wherein the first cutting profile is substantially circular and has a first radius of curvature, and wherein the second cutting profile is substantially circular and has a second radius of curvature.

4. The apparatus of claim 2, wherein the plurality of cutting profiles includes a first cutting profile and a second cutting profile disposed about 180 degrees from the first cutting profile.

5. The apparatus of claim 1, wherein the cutting assembly is rotatably coupled to the first member, and wherein the active cutting profile is selectable by rotation of the cutting assembly.

6. The apparatus of claim 1, further including a selection member operatively coupled to the cutting assembly and orientable between an unsecured orientation and a secured orientation,
wherein the active cutting profile is selectable from among the plurality of cutting profiles when the selection member is in the unsecured configuration, and
wherein the active cutting profile is substantially fixed with respect to the first member where the selection member is in the secured configuration.

7. The apparatus of claim 6, wherein the selection member is at least partially received in the first member when the selection member is in the secured orientation, and wherein the selection member is at least partially elevated away from the first member when the selection member is in the unsecured orientation.

8. The apparatus of claim 1, wherein the cutting element is removable from the apparatus and is interchangeable with a new cutting element.

9. An apparatus for cutting a portion from sheet material, comprising:
a first member operatively coupled to a second member; and
a cutting assembly operatively coupled to the first member, the cutting assembly comprising:
a housing including an upper surface and a lower surface;
a cutting element slidingly constrained between the upper surface and the lower surface, the cutting element including a plurality of cutting profiles;
at least one biasing member disposed between the cutting element and the upper surface, the at least one biasing member biasing the first member away from the second member; and
a selection member operatively coupled to the cutting assembly,
wherein an active cutting profile is selectable from among the plurality of cutting profiles by operation of the selection member, and
wherein the active cutting profile is engageable with one or more pieces of sheet material.

10. The apparatus of claim 9, wherein each of the plurality of cutting profiles has a unique cutting profile.

11. The apparatus of claim 10, wherein the plurality of cutting profiles includes a first cutting profile and a second cutting profile disposed about 180 degrees from the first cutting profile.

12. The apparatus of claim 11, wherein the cutting profile is substantially circular and has a first radius of curvature and the second cutting profile is substantially circular and has a second radius of curvature.

13. The apparatus of claim 12, wherein the cutting assembly is rotatably coupled to the first member, and wherein the active cutting profile is selectable by rotation of the selection member.

14. The apparatus of claim 9 wherein the selection member is orientable between an unsecured orientation and a secured orientation,
wherein the active cutting profile is selectable from among the plurality of cutting profiles when the selection member is in the unsecured orientation, and
wherein the active cutting profile is substantially fixed with respect to the first member when the selection member is in the secured orientation.

15. The apparatus of claim 14, wherein the selection member is at least partially received in the first member when the selection member is in the secured orientation, and wherein the selection member is at least partially elevated away from the first member when the selection member is in the unsecured orientation.

16. The apparatus of claim 9, wherein the cutting assembly is removable and interchangeable with a new cutting assembly.

17. An apparatus for cutting a portion from sheet material, comprising:
a first member operatively coupled to a second member;
a cutting assembly rotatably coupled to the first member; and
a selection member rotatably coupled to the cutting assembly, the selection member orientable between an unsecured orientation and a secured orientation,
wherein an active cutting profile is selectable from among the plurality of cutting profiles by rotation of the selection member when the selection member is in the unsecured orientation,
wherein the active cutting profile is substantially fixed with respect to the first member when the selection member is in the secured orientation, and
wherein the active cutting profile is engageable with one or more pieces of sheet material.

18. The apparatus of claim 17, wherein the selection member is at least partially received in the first member when the selection member is in the secured orientation, and wherein the selection member is at least partially elevated away from the first member when the selection member is in the unsecured orientation.

19. The apparatus of claim 17, wherein the cutting assembly is rotatable about an axis substantially normal to a plane defined by one or more pieces of sheet material engageable by the active cutting profile.

20. The apparatus of claim 19, wherein the plurality of cutting profiles includes a first cutting profile and a second cutting profile disposed about 180 degrees from the first cutting profile.
